(19) United States
(12) Patent Application Publication
(10) Pub. No.: US 2025/0251809 A1
(43) Pub. Date: Aug. 7, 2025

(54) WEARABLE ELECTRONIC DEVICE AND CONTROL METHOD OF WEARABLE ELECTRONIC DEVICE

(71) Applicant: SAMSUNG ELECTRONICS CO., LTD., Suwon-si (KR)

(72) Inventors: Jinik KIM, Suwon-si (KR); Namjoon PARK, Suwon-si (KR)

(73) Assignee: SAMSUNG ELECTRONICS CO., LTD., Suwon-si (KR)

(21) Appl. No.: 19/072,467

(22) Filed: Mar. 6, 2025

Related U.S. Application Data
(63) Continuation of application No. PCT/KR2023/011061, filed on Jul. 28, 2023.

(30) Foreign Application Priority Data
Oct. 21, 2022 (KR) 10-2022-0136790
Nov. 3, 2022 (KR) 10-2022-0145597

(51) Int. Cl. G06F 3/041; G04G 21/08; G04G 99/00; G06F 1/16

(52) U.S. Cl. CPC G06F 3/0412; G04G 21/08; G04G 99/006; G06F 1/163

(57) ABSTRACT

Disclosed is a wearable electronic device including: a display interface with a display and a touch circuit, a sensor interface including a first sensor and a second sensor. The wearable electronic device identifies whether the wearable electronic device is worn on a wrist of a user, by using the first sensor; based on identifying the wearable electronic device is worn on the wrist of the user, monitors a state of the wearable electronic device by using the second sensor, identifies whether the wearable electronic device is in a first state or a second state, and based on the wearable electronic device being in the first state, controls a touch sensitivity or a touch region of the display interface.

### CROSS-REFERENCE TO RELATED APPLICATIONS

This application is a continuation application of International Application No. PCT/KR2023/011061, filed on Jul. 28, 2023, which claims priority to Korean Patent Application No. 10-2022-0136790, filed on Oct. 21, 2022, in the Korean Intellectual Property Office, and Korean Patent Application No. 10-2022-0145597, filed on Nov. 3, 2022, in the Korean Intellectual Property Office, the disclosures of which are incorporated by reference herein in their entireties.

### BACKGROUND

### 1. Field

The disclosure relates to a wearable electronic device and a method for controlling the wearable electronic device.

### 2. Description of Related Art

The use of a wearable electronic device that a user can wear on his/her body (e.g., a wrist) is increasing, and various functions are being provided to the wearable electronic device.

The wearable electronic device may be attached to a part of the user's body or detached from the user's body by using at least one strap.

The wearable electronic device may be linked with another electronic device (e.g., a smart phone) to provide various services to the user.

### SUMMARY

A wearable electronic device may install various types of applications in a memory and provide various information, such as text, images, or videos, to a user by using a display.

The various types of applications installed in the wearable electronic device may be selectively executed by the user touching the display.

The wearable electronic device may execute an operation or launch an application even when the user unintentionally touches the display. For example, when the user wearing the wearable electronic device crosses his/her arms, the right wrist and the left wrist may overlap, causing an undesired touch on the display and launching an application.

If the user's undesired or incorrect touch occurs on the display, an initial screen or configuration of the wearable electronic device may be changed. If the user's undesired touch occurs on the display, the user of the wearable electronic device may experience inconvenience.

Various embodiments of the disclosure may provide a method capable of identifying a direction or an angle of a wearable electronic device by using a sensor module (e.g., an inertial sensor) and controlling touch sensitivity and a touch region of a display.

Various embodiments of the disclosure may provide a wearable electronic device and a method for controlling the wearable electronic device, the wearable electronic device being capable of identifying whether the wearable electronic device is in a first state (e.g., out of view) or a second state (e.g., in of view) by using a sensor module (e.g., an inertial sensor), and reducing touch sensitivity or a touch region of a display when the wearable electronic device is in the first state in which the wearable electronic device does not face a user's body (e.g., eyes).

According to an aspect of the disclosure, there is provided a wearable electronic device including: a display interface including a display and a touch circuit; a sensor interface including a first sensor and a second sensor; a memory configured to store instructions; and at least one processor operatively connected to the display interface, the sensor interface, and the memory, wherein the instructions, when executed by the at least one processor, cause the wearable electronic device to: identify whether the wearable electronic device is worn on a wrist of a user, by using the first sensor; based on identifying the wearable electronic device is worn on the wrist of the user, monitor a state of the wearable electronic device by using the second sensor; identify whether the wearable electronic device is in a first state or a second state; and based on the wearable electronic device being in the first state, control a touch sensitivity or a touch region of the display interface.

The instructions, when executed by the at least one processor, may cause the wearable electronic device to identify, as the first state, a case in which the display is positioned to face a direction away from a body of the user of the wearable electronic device, by using the second sensor.

The instructions, when executed by the at least one processor, may cause the wearable electronic device to identify, as the second state, a case in which the display is positioned to face a body of the user of the wearable electronic device, by using the second sensor.

The instructions, when executed by the at least one processor, may cause the wearable electronic device to, using the sensor interface, identify, as the first state: a case in which the user of the wearable electronic device crosses arms and thus the display faces a direction away from the a body of the user, a case in which the display faces a direction away from the body of the user in a state in which the user lowers the wrist wearing the wearable electronic device, or a case in which the user places the wrist wearing the wearable electronic device) in a predetermined location.

The instructions, when executed by the at least one processor, may cause the wearable electronic device to, using the second sensor, identify, as the first state, a case in which the user of the wearable electronic device does not view or is unable to view the display through eyes, and identify, as the second state, a case in which the user of the wearable electronic device views or is able to view the display through the eyes.

The instructions, when executed by the at least one processor, may cause the wearable electronic device to, based on the wearable electronic device being in the first state, reduce the touch sensitivity or the touch region of the display interface.

The sensor interface may further include a fourth sensor, and wherein the instructions, when executed by the at least one processor, may cause the wearable electronic device to, using the fourth sensor, determine whether to enter an initial screen displayed on the display interface, based on an intensity or a magnitude of a pressure applied to the display interface.

The instructions, when executed by the at least one processor, may cause the wearable electronic device to, based on the wearable electronic device being in the first state, shorten a time for entering an initial screen of the wearable electronic device displayed through the display interface.

The instructions, when executed by the at least one processor, may cause the wearable electronic device to determine whether to enter an initial screen displayed on the display interface, based on a shape or an area of a touch point on the display interface.

The instructions, when executed by the at least one processor, may cause the wearable electronic device to change an initial screen displayed on the display interface or restrict a change of the initial screen, based on a shape or an area of a touch point on the display interface.

According to an aspect of the disclosure, there is provided a method for controlling a wearable electronic device, the method including: identifying, by at least one processor, whether the wearable electronic device is worn on a wrist of a user, by using a first sensor; based on identifying the wearable electronic device is worn on the wrist of the user, monitoring, by the at least one processor, a state of the wearable electronic device by using a second sensor; identifying, by the at least one processor, whether the wearable electronic device is in a first state or a second state by using the second sensor; and based on the wearable electronic device being in the first state, controlling, by the at least one processor, a touch sensitivity or a touch region of a display interface.

The method may include identifying, by the at least one processor, a case in which a display of the display interface is positioned to face a direction away from a body of the user of the wearable electronic device, as the first state, by using the second sensor.

The method may include identifying, by the at least one processor, a case in which the display is positioned to face the body of the user of the wearable electronic device, as the second state, by using the second sensor.

The method may include identifying, by the at least one processor, using the second sensor, as the first state: a case in which the user of the wearable electronic device crosses arms and thus a display of the display interface faces a direction away from a body of the user, a case in which the display faces a direction away from the body of the user in a state in which the user lowers the wrist wearing the wearable electronic device, or a case in which the user places the wrist wearing the wearable electronic device in a predetermined location.

The method may include identifying, by the at least one processor, a state in which the user of the wearable electronic device does not view or is unable to view a display of the display interface through eyes, as the first state, by using the second sensor; and identifying, as the second state, a state in which the user of the wearable electronic device views or is able to view the display through the eyes.

According to various embodiments of the disclosure, when a wearable electronic device is in a first state (e.g., out of view) in which the wearable electronic device does not face a user's body (e.g., eyes), touch sensitivity or a touch region of a display is reduced by using a sensor module, so that malfunction of the wearable electronic device can be reduced.

In addition, various effects directly or indirectly identified through this document may be provided.

### BRIEF DESCRIPTION OF THE DRAWINGS

In relation to the description of drawings, the same or similar reference numerals may be used for the same or similar components.

The above and other aspects and/or features of embodiments of the present disclosure will be more apparent from the following description taken in conjunction with the accompanying drawings, in which:

FIG. 1A is a block diagram of an electronic device in a network environment according to various embodiments of the disclosure;

FIG. 1B is a block diagram of a display module (e.g., display interface) according to various embodiments of the disclosure;

FIG. 2A is a perspective view schematically illustrating a front surface of a wearable electronic device according to an embodiment of the disclosure;

FIG. 2B is a perspective view schematically illustrating a rear surface of the wearable electronic device disclosed in FIG. 2A;

FIG. 3 is a drawing schematically illustrating an expanded perspective view of the wearable electronic device disclosed in FIG. 2A;

FIG. 4 is a block diagram schematically illustrating a configuration of a wearable electronic device according to an embodiment of the disclosure;

FIGS. 5A to 5C are drawings schematically illustrating embodiments in which a wearable electronic device detects a first state by using a second sensor according to an embodiment of the disclosure;

FIG. 6 is a drawing schematically illustrating a configuration capable of identifying whether a wearable electronic device is in a first state or a second state by using a second sensor according to an embodiment of the disclosure;

FIG. 7 is a drawing schematically illustrating an embodiment for describing axis calibration for a second sensor of a wearable electronic device according to an embodiment of the disclosure;

FIG. 8A is a drawing schematically illustrating a raw acceleration signal measured using a second sensor of a wearable electronic device according to an embodiment of the disclosure;

FIG. 8B is a drawing schematically illustrating a signal obtained by filtering the raw acceleration signal of FIG. 8A measured using a second sensor of a wearable electronic device according to an embodiment of the disclosure;

FIG. 9 is a drawing schematically illustrating an embodiment for reducing a touch region of a display module of a wearable electronic device according to an embodiment of the disclosure;

FIG. 10 is a drawing schematically illustrating an embodiment of adjusting a long press input time for a display module of a wearable electronic device according to an embodiment of the disclosure;

FIG. 11 is a drawing schematically illustrating an embodiment of entering an initial screen by using the shape or size of a touch input to a display module of a wearable electronic device according to an embodiment of the disclosure;

FIG. 12 is a drawing schematically illustrating an embodiment of changing an initial screen for a display module of a wearable electronic device according to an embodiment of the disclosure; and

FIG. 13 is a schematic flowchart illustrating a method for controlling a wearable electronic device according to an embodiment of the disclosure.

### DETAILED DESCRIPTION

Embodiments described in the disclosure and configurations shown in the drawings are merely examples of embodiments and may be modified in various different ways at the time of filing of the present application to replace the embodiments and drawings of the disclosure.

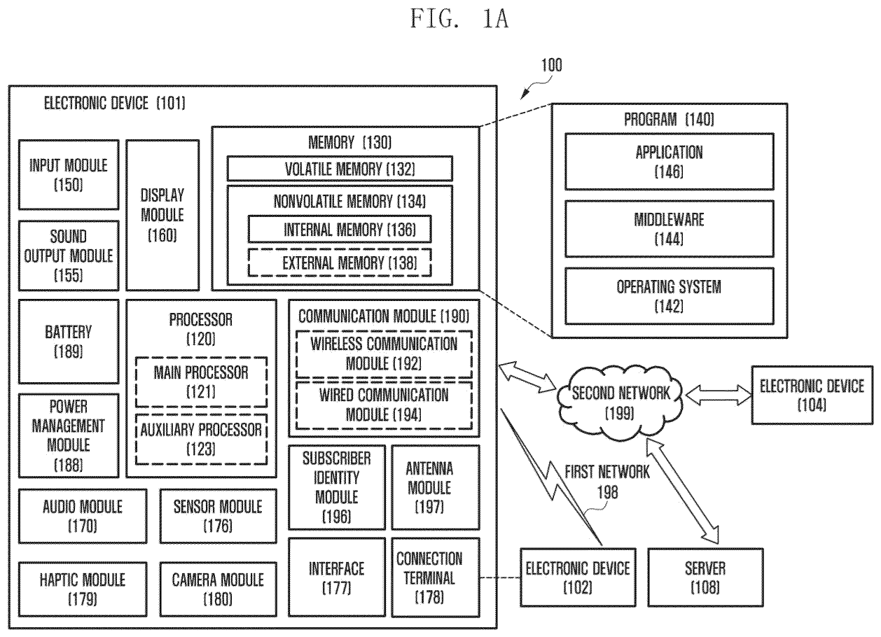

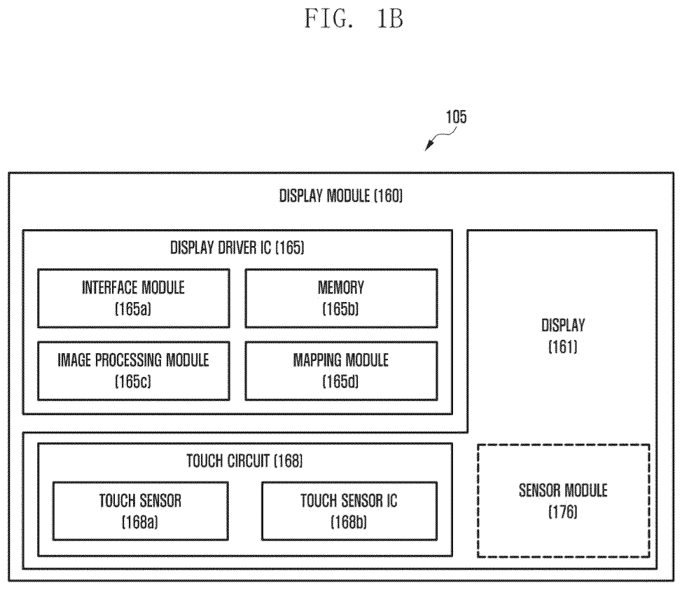

FIG. 1A is a block diagram illustrating an electronic device 101 in a network environment 100 according to various embodiments.

Referring to FIG. 1A, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160 (e.g., display interface 160), an audio module 170, a sensor module 176 (e.g., sensor interface 176), an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

FIG. 1B is a block diagram 105 illustrating the display module 160 according to various embodiments.

Referring to FIG. 1B, the display module 160 may include a display 161 and a display driver integrated circuit (DDI) 165 to control the display 161. The DDI 165 may include an interface module 165a, memory 165b (e.g., buffer memory), an image processing module 165c, or a mapping module 165d. The DDI 165 may receive image information that contains image data or an image control signal corresponding to a command to control the image data from another component of the electronic device 101 via the interface module 165a. For example, according to an embodiment, the image information may be received from the processor 120 (e.g., the main processor 121 (e.g., an application processor)) or the auxiliary processor 123 (e.g., a graphics processing unit) operated independently from the function of the main processor 121. The DDI 165 may communicate, for example, with touch circuitry 168 or the sensor module 176 via the interface module 165a. The DDI 165 may also store at least part of the received image information in the memory 165b, for example, on a frame by frame basis. The image processing module 165c may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 161. The mapping module 165d may generate a voltage value or a current value corresponding to the image data pre-processed or post-processed by the image processing module 165c. According to an embodiment, the generating of the voltage value or current value may be performed, for example, based at least in part on one or more attributes of the pixels (e.g., an array, such as an RGB stripe or a pentile structure, of the pixels, or the size of each subpixel). At least some pixels of the display 161 may be driven, for example, based at least in part on the voltage value or the current value such that visual information (e.g., a text, an image, or an icon) corresponding to the image data may be displayed via the display 161.

According to an embodiment, the display module 160 may further include the touch circuitry 168. The touch circuitry 168 may include a touch sensor 168a and a touch sensor IC 168b to control the touch sensor 168a. The touch sensor IC 168b may control the touch sensor 168a to sense a touch input or a hovering input with respect to a certain position on the display 161. To achieve this, for example, the touch sensor 168a may detect (e.g., measure) a change in a signal (e.g., a voltage, a quantity of light, a resistance, or a quantity of one or more electric charges) corresponding to the certain position on the display 121. The touch circuitry 168 may provide input information (e.g., a position, an area, a pressure, or a time) indicative of the touch input or the hovering input detected via the touch sensor 168a to the processor 120. According to an embodiment, at least part (e.g., the touch sensor IC 168b) of the touch circuitry 168 may be formed as part of the display 121 or the DDI 165, or as part of another component (e.g., the auxiliary processor 123) disposed outside the display module 160.

According to an embodiment, the display module 160 may further include at least one sensor (e.g., a fingerprint sensor, an iris sensor, a pressure sensor, or an illuminance sensor) of the sensor module 176 or a control circuit for the at least one sensor. In such a case, the at least one sensor or the control circuit for the at least one sensor may be embedded in one portion of a component (e.g., the display 121, the DDI 165, or the touch circuitry 168)) of the display module 160. For example, when the sensor module 176 embedded in the display module 160 includes a biometric sensor (e.g., a fingerprint sensor), the biometric sensor may obtain biometric information (e.g., a fingerprint image) corresponding to a touch input received via a portion of the display 161. As another example, when the sensor module 176 embedded in the display module 160 includes a pressure sensor, the pressure sensor may obtain pressure information corresponding to a touch input received via a partial or whole area of the display 161. According to an embodiment, the touch sensor 168a or the sensor module 176 may be disposed between pixels in a pixel layer of the display 161, or over or under the pixel layer.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

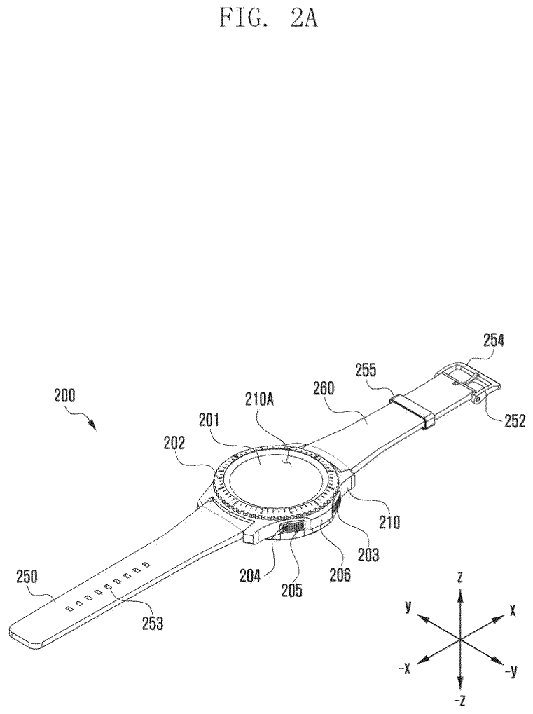

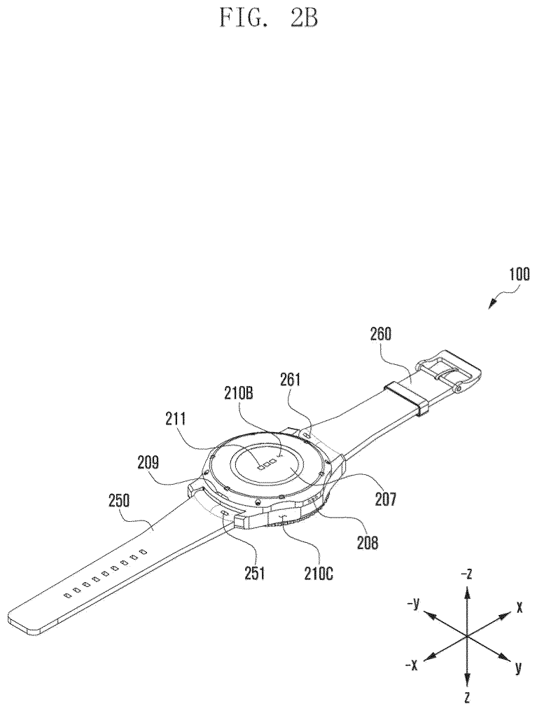

FIG. 2A is a perspective view schematically illustrating a front surface of a wearable electronic device according to an embodiment of the disclosure. FIG. 2B is a perspective view illustrating a rear surface of the wearable electronic device disclosed in FIG. 2A.

Referring to FIGS. 2A and 2B, a wearable electronic device 200 (e.g., the electronic device 101 of FIG. 1) according to an embodiment may include a housing 210 including a first surface (or a front surface) 210A facing a first direction (e.g., the z-axis direction), a second surface (or a rear surface) 210B facing a second direction (e.g., the −z-axis direction) opposite to the first direction, and a lateral surface 210C surrounding a space between the first surface 210A and the second surface 210B, and binding members 250 and 260 connected to at least a part of the housing 210 and configured to detachably bind the wearable electronic device 200 to a part (e.g., a wrist, an ankle, etc.) of a user's body. In an embodiment (not shown), the housing 210 may refer to a structure which forms a part of the first surface 210A, the second surface 210B, and the lateral surface 210C of FIG. 2A. According to an embodiment, the first surface 210A may be configured by a front plate 201 (e.g., a glass plate or a polymer plate including various coating layers), at least a part of which is substantially transparent. The second surface 210B may be configured by a rear plate 207 which is substantially opaque. The rear plate 207 may be formed of, for example, coated or colored glass, ceramic, a polymer, or a metal (e.g., aluminum, stainless steel (STS), or magnesium), or a combination of at least two of the above materials. The lateral surface 210C may be configured by a lateral bezel structure (or a lateral member) 206 coupled to the front plate 201 and the rear plate 207 and including a metal and/or a polymer. In some embodiments, the rear plate 207 and the lateral bezel structure 206 may be integrally configured and may include the same material (e.g., a metal material such as aluminum). The binding members 250 and 260 may be configured to have various materials and shapes. An integrated unit link and a plurality of unit links may be formed to be movable with respect to each other by using a woven fabric, leather, rubber, urethane, metal, ceramic, or a combination of at least two of the above materials.

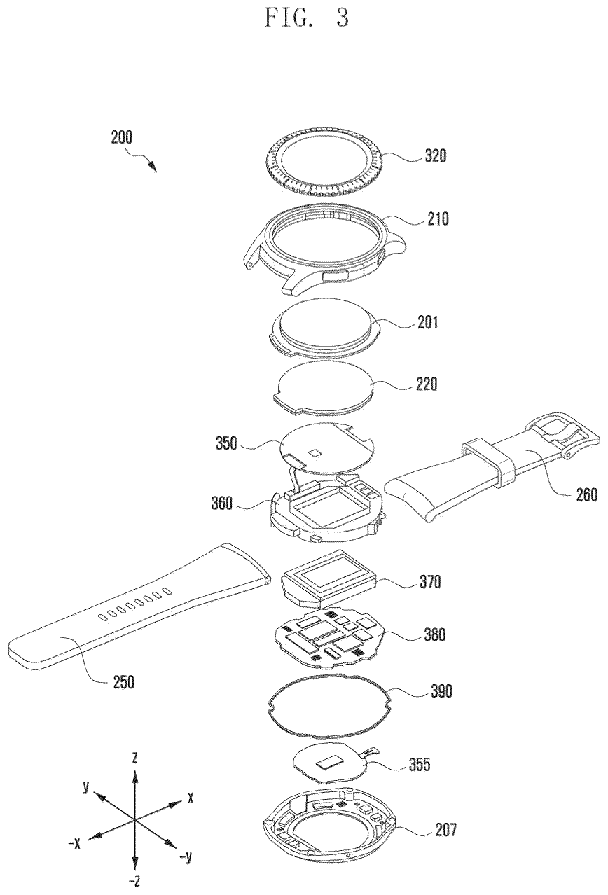

According to an embodiment, the wearable electronic device 200 may include at least one of a display 220 (e.g., the display 161 of FIG. 1B or the display 220 of FIG. 3), audio modules 205 and 208, a sensor module 211, and key input device 202, 203, and 204, and a connector hole 209. In some embodiments, the wearable electronic device 200 may not include at least one (e.g., the key input devices 202, 203, and 204, the connector hole 209, or the sensor module 211) of the above-described components or may additionally include another component.

For example, the display 220 may be exposed through a significant part of the front plate 201. The shape of the display 220 may be a shape corresponding to the shape of the front plate 201, and may have various shapes such as a circle, an oval, and a polygon. The display 220 may be coupled to or disposed adjacent to a touch detection circuit, a pressure sensor capable of measuring the intensity (pressure) of a touch, and/or a fingerprint sensor.

The audio modules 205 and 208 may include a microphone hole 205 and a speaker hole 208. The microphone hole 205 may include a microphone disposed therein so as to acquire external sound, and in some embodiments, multiple microphones may be disposed therein so as to detect the direction of sound. The speaker hole 208 may be used as an external speaker and a receiver for calls. In some embodiments, the speaker hole 208 and the microphone hole 205 may be implemented as a single hole, or a speaker (e.g., a piezo speaker) may be included without the speaker hole 208.

The sensor module 211 may generate an electrical signal or a data value corresponding to an internal operating state of the wearable electronic device 200 or an external environment state. The sensor module 211 may include, for example, a biometric sensor module 211 (e.g., an HRM sensor) disposed on the second surface 210B of the housing 210. The wearable electronic device 200 may further include a sensor module which is not illustrated, for example, at least one of a gesture sensor, an inertial sensor, a gyro sensor, a barometric pressure sensor, a magnetic sensor, an acceleration sensor, a grip sensor, a color sensor, an infrared ray (IR) sensor, a biometric sensor, a temperature sensor, a humidity sensor, or an illuminance sensor.

The key input devices 202, 203, and 204 may include a wheel key 202 disposed on the first surface 210A of the housing 210 and rotatable in at least one direction, and/or side key buttons 203 and 204 disposed on the lateral surface 210C of the housing 210. The wheel key 202 may have a shape corresponding to the shape of the front plate 201. In an embodiment, the wearable electronic device 200 may not include some or all of the above-mentioned key input devices 202, 203, and 204, and the key input devices 202, 203, and 204, which are not included therein, may be implemented in another form such as a soft key on the display 220. The connector hole 209 may include another connector hole (not shown) which may receive a connector (for example, a USB connector) for transmitting or receiving power and/or data to or from an external electronic device (e.g., the external electronic device 102, 104, and 108 of FIG. 1), and receive a connector for transmitting or receiving an audio signal to or from the external electronic device. The wearable electronic device 200 may further include, for example, a connector cover (not shown) which covers at least a part of the connector hole 209 and blocks the introduction of foreign substances into the connector hole.

The binding members 250 and 260 may be detachably bound to at least a partial region of the housing 210 by using locking members 251 and 261. The binding members 250 and 260 may include one or more of a fixing member 252, a fixing member fastening hole 253, a band guide member 254, and a band fixing ring 255.

The fixing member 252 may be configured to fix the housing 210 and the binding members 250 and 260 to a part (e.g., a wrist, an ankle, etc.) of the user's body. The fixing member fastening hole 253 may correspond to the fixing member 252 to fix the housing 210 and the binding members 250 and 260 to a part of the user's body. The band guide member 254 is configured to limit a range of movement of the fixing member 252 when the fixing member 252 is fastened to the fixing member fastening hole 253, so that the binding members 250 and 260 may be in close contact with a part of the user's body so as to be bound. The band fixing ring 255 may limit a range of movement of the binding members 250 and 260 in a state in which the fixing member 252 and the fixing member fastening hole 253 are fastened to each other.

FIG. 3 is a drawing schematically illustrating an expanded perspective view of the wearable electronic device disclosed in FIG. 2A.

Referring to FIG. 3, the wearable electronic device 200 may include the housing 210 (e.g., a lateral bezel structure), the wheel key 202, the front plate 201, the display 220, a first antenna 350, a second antenna 355, a support member 360 (e.g., a bracket), a battery 370, a printed circuit board 380, a sealing member 390, the rear plate 207, and the binding members 250 and 260. At least one of the components of the wearable electronic device 200 may be the same as or similar to at least one of the components of the electronic device 101 disclosed in FIG. 1A or the wearable electronic device 200 disclosed in FIGS. 2A and 2B, and a redundant description thereof is omitted below. The support member 360 may be disposed inside the wearable electronic device 200 and connected to the housing 210, or may be integrally formed with the housing 210. The support member 360 may be made of, for example, a metal material and/or a non-metal (e.g., polymer) material. The support member 360 may have one surface (e.g., the z-axis direction) to which the display 220 (e.g., the display module 160 of FIG. 1A) is coupled, and the other surface (e.g., the −z-axis direction) to which the printed circuit board 380 is coupled. The printed circuit board 380 may be equipped with a processor (e.g., the processor 120 of FIG. 1A), a memory (e.g., the memory 130 of FIG. 1A), a sensor module (e.g., the sensor module 176 of FIG. 1A and/or the sensor module 211 of FIG. 2B), and/or an interface (e.g., the interface 177 of FIG. 1A). The processor 120 may include, for example, one or more of a central processing unit, an application processor, a graphics processing unit (GPU), an application processor sensor processor, or a communication processor.

The memory 130 may include, for example, a volatile memory or a non-volatile memory.

A sensor module (e.g., the sensor module 176 of FIG. 1A and/or the sensor module 211 of FIG. 2B) may include at least one of an infrared ray (IR) sensor, an illuminance sensor, a proximity sensor, a touch sensor, an inertial sensor, a gyro sensor, an acceleration sensor, and/or a pressure sensor.

The interface 177 may include, for example, a high definition multimedia interface (HDMI), a universal serial bus (USB) interface, an SD card interface, and/or an audio interface. For example, the interface may electrically or physically connect the wearable electronic device 200 to an external electronic device, and include a USB connector, an SD card/MMC connector, or an audio connector.

The battery 370 is a device for supplying power to at least one component of the wearable electronic device 200 and may include, for example, a non-rechargeable primary cell, a rechargeable secondary cell, or a fuel cell. For example, at least a part of the battery 370 may be disposed substantially on the same plane as the printed circuit board 380. The battery 370 may be integrally disposed inside the wearable electronic device 200 or may be disposed to be detachable from the wearable electronic device 200.

The first antenna 350 may be disposed between the display 220 (e.g., the display module 160 of FIG. 1A) and the support member 360. The first antenna 350 may include, for example, a near field communication (NFC) antenna, a wireless charging antenna, and/or a magnetic secure transmission (MST) antenna. For example, the first antenna 350 may perform short-range communication with an external device or wirelessly transmit/receive power required for charging, and transmit a magnetic-based signal including a short-range communication signal or payment data. In an embodiment, an antenna structure may be configured by a part of the housing 210 and/or the support member 360 or a combination thereof.

The second antenna 355 may be disposed between the printed circuit board 380 and the rear plate 207. The second antenna 355 may include, for example, a near field communication (NFC) antenna, a wireless charging antenna, and/or a magnetic secure transmission (MST) antenna. For example, the second antenna 355 may perform short-range communication with an external device or wirelessly transmit/receive power required for charging, and transmit a magnetic-based signal including a short-range communication signal or payment data. In an embodiment, an antenna structure may be configured by a part of the housing 210 and/or the rear plate 207 or a combination thereof.

The sealing member 390 may be positioned between the housing 210 and the rear plate 207. The sealing member 390 may be configured to block moisture and foreign substances from being introduced into a space surrounded by the housing 210 and the rear plate 207 from the outside.

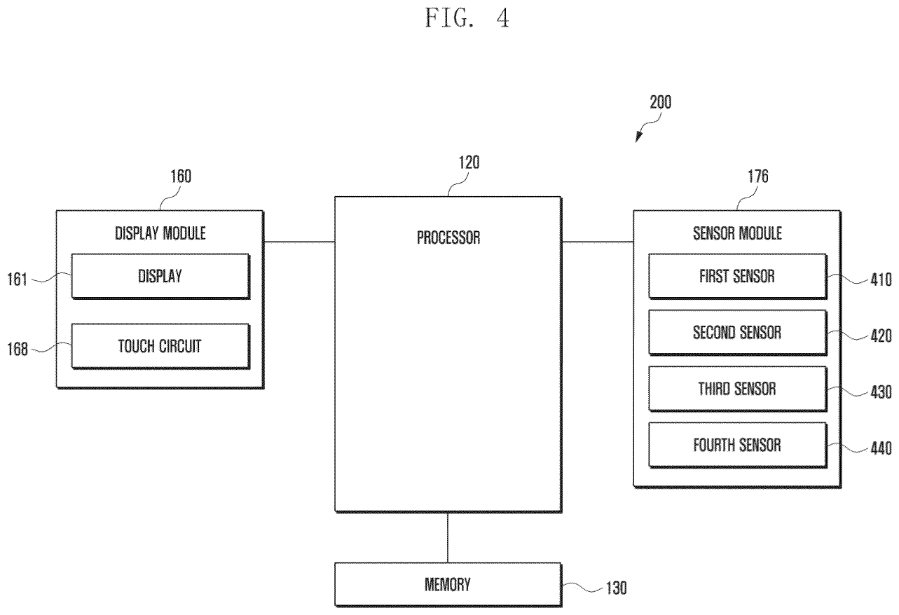

FIG. 4 is a block diagram schematically illustrating a configuration of a wearable electronic device according to an embodiment of the disclosure.

According to various embodiments, the wearable electronic device 200 disclosed in FIG. 4 may include at least some of the embodiments disclosed in the electronic device 101 disclosed in FIG. 1A or the electronic device 200 disclosed in FIGS. 2A to 3. In the description of the embodiments disclosed in FIG. 4, the same reference numerals are given to components that are substantially the same as those disclosed in the embodiments disclosed in FIGS. 1A to 3, and redundant descriptions of their functions may be omitted.

According to an embodiment, although various embodiments of the disclosure are described below as being applied to the wearable electronic device 200 that can be worn on a part (e.g., a wrist) of a user's body, various embodiments of the disclosure are not limited to the wearable electronic device 200, and may also be substantially equally applied to other electronic devices, such as bar-type, foldable-type, rollable-type, and/or sliding-type devices.

Referring to FIG. 4, the wearable electronic device 200 according to an embodiment of the disclosure may include the display module 160, the sensor module 176, the memory 130, and/or the processor 120.

According to various embodiments, the sensor module 176, the memory 130 and/or the processor 120 may be disposed on the printed circuit board 380 disclosed in FIG. 3. The display module 160, the sensor module 176, the memory 130, and the processor 120 may be operatively connected.

According to an embodiment, the display module 160 may display an initial screen, a configuration screen, and various applications of the wearable electronic device 200. The display module 160 may display a user interface (UI) related to an application that may provide various services to a user. The display module 160 may transmit touch information input by the user to the processor 120. Based on a touch area input by the user, the display module 160 (e.g., the DDI 165 or the touch sensor IC 168b of FIG. 1B) may detect whether a touch is made by the user's finger when a touch area for the display module 160 of the wearable electronic device 200 is small, and detect whether a touch is made by the user's wrist when the touch area for the display module 160 is large. The display module 160 (e.g., the touch circuit 168 of FIG. 1B) may control at least one of touch sensitivity and a touch region (e.g., a touch area) according to the control of the processor 120.

According to various embodiments, the display module 160 may perform a display function and an input function. The display module 160 may include the display 161 and the touch circuit 168 in order to perform the display function and the input function. The display 161 may visually provide the user with a menu, input data, function configuration information, and various information (e.g., a user interface, an icon, and/or an application) of the wearable electronic device 200. The touch circuit 168 may include a touch sensor such as a capacitive overlay, resistive overlay, or infrared beam touch sensor, or a pressure sensor. In addition to the above sensors, various types of sensing means capable of detecting contact or pressure of an object (a finger or a stylus pen) may be configured as the touch circuit 168. The touch circuit 168 may detect a touch (e.g., a finger or a stylus pen) of the user of the wearable electronic device 200, and transmit a detected signal to the processor 120. The detected signal may include at least one of coordinate information, direction information, or touch angle information of a touch input by the user of the wearable electronic device 200.

According to an embodiment, the sensor module 176 may detect a state such as whether the wearable electronic device 200 is worn, a direction, and/or an angle, and transmit an electrical signal or a data signal corresponding to the detected state to the processor 120.

According to various embodiments, the sensor module 176 may include at least one of a first sensor 410, a second sensor 420, a third sensor 430, and a fourth sensor 440. For example, the first sensor 410 may include an infrared sensor. For example, the second sensor 420 may include an inertial sensor. For example, the third sensor 430 may include an illuminance sensor. For example, the fourth sensor 440 may include a pressure sensor. The sensor module 176 is not limited to the first sensor 410 to the fourth sensor 440 described above, and may include, for example, at least one of a gesture sensor, a gyro sensor, an acceleration sensor, an angular velocity sensor, a pressure sensor, a magnetic sensor, a grip sensor, a proximity sensor, a color sensor, an ultraviolet sensor, a biometric sensor, a temperature sensor, or a humidity sensor.

According to an embodiment, the first sensor 410 may sense or detect whether the wearable electronic device 200 is worn on a part (e.g., a wrist) of the user's body. For example, the first sensor 410 may be disposed on the rear surface (e.g., the −z-axis direction) of the wearable electronic device 200 disclosed in FIG. 2B.

According to various embodiments, the first sensor 410 capable of detecting whether the user has worn the wearable electronic device 200 on a part (e.g., a wrist) of the body may include an infrared sensor, a proximity sensor, a temperature sensor, a biometric sensor, or an ultraviolet sensor.

According to an embodiment, the second sensor 420 may detect the movement of the wearable electronic device 200. The second sensor 420 may detect a gravitational acceleration of each axis of the wearable electronic device 200. The second sensor 420 may detect a physical quantity related to the movement of the wearable electronic device 200, for example, at least one of a direction, an angular velocity, an acceleration, and a position of the wearable electronic device 200. The second sensor 420 may detect a direction of the wearable electronic device 200 or a change in the direction.

According to various embodiments, the second sensor 420 may include an inertial sensor, an acceleration sensor, an orientation sensor, an angular velocity sensor (e.g., a gyro sensor), or a geomagnetic sensor. For example, the inertial sensor may measure a physical quantity related to the movement of the wearable electronic device 200. For example, the acceleration sensor may measure an acceleration acting with reference to each axis of the wearable electronic device 200. The orientation sensor may measure a force applied to the wearable electronic device 200, based on the measured acceleration. The angular velocity sensor (e.g., a gyro sensor) may measure an angular velocity or an angle (e.g., tilt) acting with reference to each axis of the wearable electronic device 200. The orientation sensor may measure the amount of rotation about each axis of the wearable electronic device 200, based on the measured angular velocity. The geomagnetic sensor may measure an orientation of the wearable electronic device 200 by using magnetic north.

According to various embodiments, the second sensor 420 (e.g., an inertial sensor) may detect (e.g., a second state) whether the display module 160 is positioned to face the inside of the body of the user of the wearable electronic device 200 (e.g., an inward tilt). For example, the second sensor 420 may detect whether the display module 160 of the wearable electronic device 200 is positioned to face the user's body (e.g., torso or eyes). The second sensor 420 may detect (e.g., a first state) whether the display module 160 is positioned to face the outside of the body of the user of the wearable electronic device 200 (e.g., an outward tilt). For example, the second sensor 420 may detect whether the display module 160 of the wearable electronic device 200 is positioned to face a direction opposite to the direction toward the user's body (e.g., torso or eyes). Based on tilted directions (e.g., an angle) with respect to the x, y, and z-axis directions, the second sensor 420 (e.g., an inertial sensor) may detect a second state in which the display module 160 of the wearable electronic device 200 faces the user's body (e.g., torso or eyes) or a first state in which the display module 160 faces a direction opposite to the direction toward the user's body (e.g., torso).

According to various embodiments, the wearable electronic device 200 may detect whether the wearable electronic device 200 is in the first state (e.g., out of view) in which the user does not view or cannot view the display 161 (e.g., a screen) through his/her eyes or in the second state (e.g., in of view) in which the user views or can view the display 161 (e.g., a screen) through his/her eyes, by using the second sensor 420 (e.g., an inertial sensor). The first state (e.g., out of view) may be a state in which the display 161 (e.g., a screen) of the wearable electronic device 200 does not face the user's body (e.g., torso or eyes). According to an embodiment, the first state may be a state in which the wearable electronic device 200 is within a first angle range and/or a first acceleration range. For example, the first state may include a case in which the user of the wearable electronic device 200 crosses his/her arms and thus the display 161 (e.g., a screen) faces a direction (e.g., outward) opposite to the direction toward the body, a case in which the display 161 (e.g., a screen) faces a direction opposite to the direction toward the body in a state where the user lowers his/her wrist wearing the wearable electronic device 200, or a state in which the user places his/her wrist wearing the wearable electronic device 200 in a pocket and is thus unable to view the display 161 (e.g., a screen). The second state (e.g., in of view) may be a state in which the display 161 (e.g., a screen) of the wearable electronic device 200 faces the user's body (e.g., eyes). According to an embodiment, the second state may be a state in which the wearable electronic device 200 is within a second angle range and/or a second acceleration range. For example, the second state may be a state other than the first state described above. For example, the second state may include a case in which the user looks at a clock displayed on the display 161 (e.g., a screen) through his/her eyes or a case in which the user runs an application displayed on the display 161 (e.g., a screen) through his/her eyes.

According to an embodiment, the third sensor 430 may detect whether the wearable electronic device 200 is positioned in a predetermined location (e.g., a pocket). For example, the third sensor 430 may include at least one of an illuminance sensor, a proximity sensor, a biometric sensor, an infrared sensor, or an ultraviolet sensor.

According to an embodiment, the fourth sensor 440 may detect a pressure applied to the display module 160 of the wearable electronic device 200. The fourth sensor 440 may be included in the display module 160. For example, the fourth sensor 440 may be included in the display 161, such as the touch circuit 168. The fourth sensor 440 may detect whether a pressure applied to the display module 160 of the wearable electronic device 200 is a pressure applied by the user's finger or a pressure applied by the user's wrist, based on the intensity or magnitude of the pressure applied to the display module 160.

According to an embodiment, the memory 130 may store a configuration value related to at least one of touch sensitivity, a touch region (e.g., a touch area), and a touch pressure of the wearable electronic device 200. The memory 130 may store at least one instruction related to the touch sensitivity, the touch region (e.g., a touch area), and/or the touch pressure of the wearable electronic device 200. The memory 130 may store an initial screen, a configuration screen, and various applications of the wearable electronic device 200. The memory 130 may store a user interface (UI) related to an application that may provide various services to the user of the wearable electronic device 200.

According to various embodiments, the memory 130 may perform a function of storing a program (e.g., the program 140 of FIG. 1A) for processing and controlling the processor 120, an operating system (e.g., the operating system 142 of FIG. 1A), various applications, and input/output data. The memory 130 may store a program for controlling the overall operation of the wearable electronic device 200. The memory 130 may store various configuration information required for processing a function in the wearable electronic device 200.

According to an embodiment, the processor 120 may be operatively connected to the display module 160, the sensor module 176, and the memory 130. The processor 120 may control functions and operations of the display module 160, the sensor module 176, and the memory 130. The processor 120 may receive at least one of a touch signal, a pressure signal, and a sensing signal transmitted through the display module 160 and the sensor module 176. The processor 120 may identify direction, speed, and/or angle information of the wearable electronic device 200 transmitted through the sensor module 176 (e.g., the second sensor 420), and reduce at least one of touch sensitivity, a touch region (e.g., a touch area), and a touch pressure of the display module 160 (e.g., the touch circuit 168). The processor 120 may identify whether the wearable electronic device 200 is in a first state (out of view) in which the display 161 (e.g., a screen) of the wearable electronic device 200 faces a direction opposite to the direction toward the user's body (e.g., eyes or torso) or in a second state (in of view) in which the display 161 (e.g., a screen) of the wearable electronic device 200 faces the user's body (e.g., eyes or torso), based on the direction, speed, and/or angle information of the wearable electronic device 200 transmitted through the sensor module 176 (e.g., the second sensor 420). The processor 120 may reduce at least one of the touch sensitivity, the touch region (e.g., a touch area), and the touch pressure of the display module 160 (e.g., the touch circuit 168) when the wearable electronic device 200 is in the first state (out of view) in which the display 161 faces the direction opposite to the direction toward the user's body (e.g., eyes or torso). According to an embodiment, the processor 120 may use the third sensor 430 to identify that the wearable electronic device 200 is inserted into a predetermined location (e.g., a pocket) and thus is in the first state (out of view) in which the user cannot view the display 161 (e.g., a screen). For example, the processor 120 may identify or determine, as the first state, a case in which the wearable electronic device 200 is located in a predetermined location or covered by clothing and thus a sensing value (e.g., an illuminance value) decreases, through the third sensor 430 (e.g., an illuminance sensor, a proximity sensor, a biometric sensor, an infrared sensor, or an ultraviolet sensor). The processor 120 may use the third sensor 430 to identify that the wearable electronic device 200 is in the first state in which the wearable electronic device 200 is inserted into the user's pocket, and reduce the touch sensitivity of the display module 160 (e.g., the touch circuit 168). For example, when the touch sensitivity of the display module 160 (e.g., the touch circuit 168) is within a normal range of about 70% to about 100%, if the wearable electronic device 200 is in the first state, the processor 120 may reduce the touch sensitivity of the display module 160 (e.g., the touch circuit 168) by about 10% to about 30%.

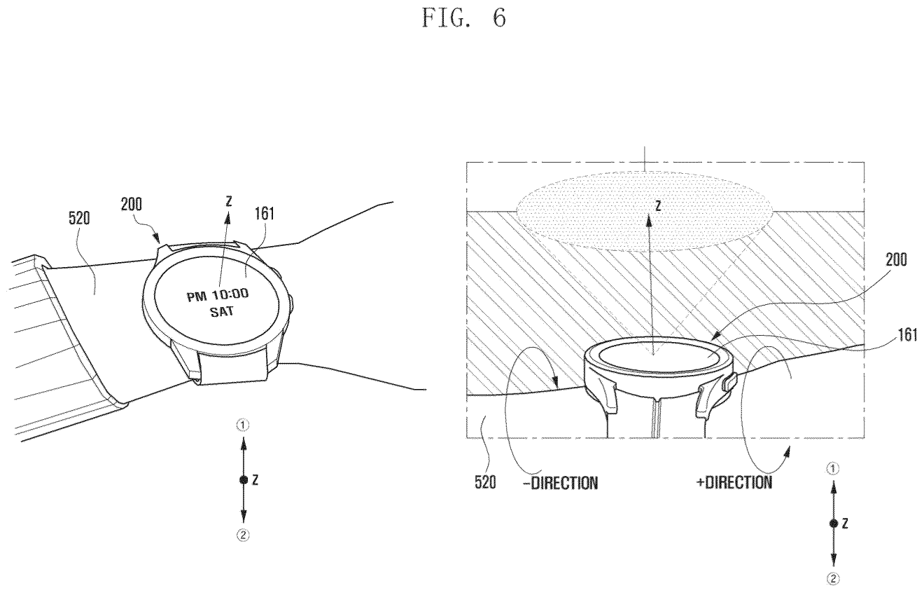

According to an embodiment, when the user lowers his/her wrist wearing the wearable electronic device 200, the processor 120 may use the second sensor 420 to identify, as the first state, a case in which a gravity value measured in one direction (e.g., 1) direction of FIG. 6) is about −1. When the user lowers his/her wrist wearing the wearable electronic device 200, the processor 120 may identify the first state by using the second sensor 420, based on a value of an angle tilted in the direction of about −90° with reference to a vertical axis (e.g., the z-axis).

According to an embodiment, the processor 120 may perform a function of controlling the overall operation of the wearable electronic device 200 and a signal flow between internal components, and processing data. The processor 120 may include, for example, a central processing unit (CPU), an application processor, and/or a communication processor. The processor 120 may include a single core processor or a multi-core processor. The processor 120 may be configured by at least one processor. For example, the processor 120 may include an application processor (e.g., the main processor 121 of FIG. 1A) and a sensor hub processor (e.g., the auxiliary processor 123 of FIG. 1A). The sensor hub processor may be operatively connected to the sensor module 176 to perform various sensing through the sensor module 176 and transmit information related thereto to the application processor.

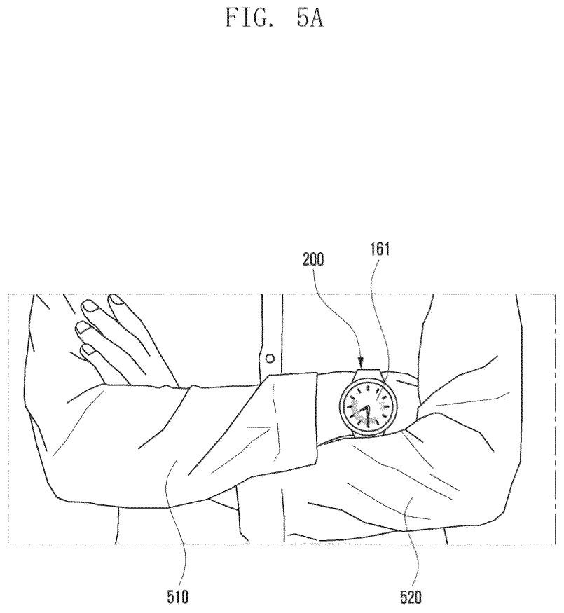

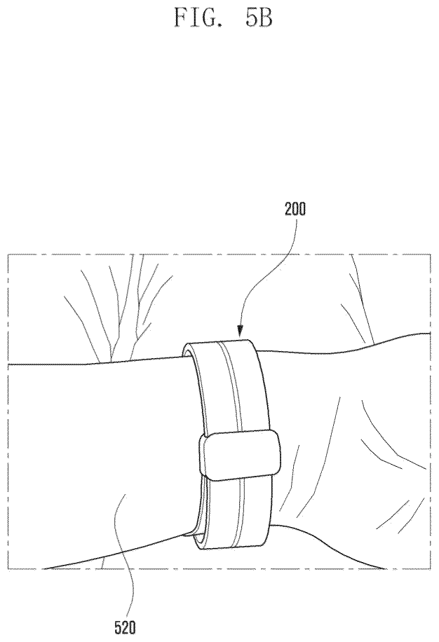

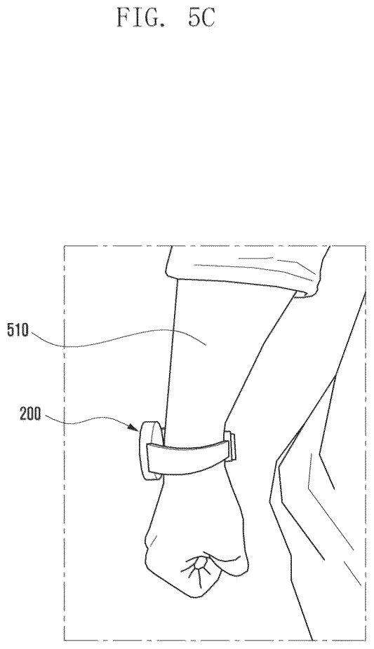

FIGS. 5A to 5C are drawings schematically illustrating embodiments in which a wearable electronic device detects a first state by using a second sensor according to an embodiment of the disclosure.

According to an embodiment, the wearable electronic device 200 may detect a first state (e.g., out of view) in which the display 161 (e.g., a screen) is tilted in a direction (e.g., outward) opposite to the direction toward a user's body (e.g., eyes or torso) or a second state (e.g., in of view) in which the display 161 (e.g., a screen) is tilted in a direction (e.g., inward) toward the user's body (e.g., eyes or torso), by using the second sensor 420 (e.g., an inertial sensor) and the processor 120.

According to an embodiment, the first state may be a state in which the wearable electronic device 200 is within a first angle range and/or a first acceleration range. For example, the first state may include a state in which the display module 160 of the wearable electronic device 200 is positioned to face a direction opposite to the direction toward the user's body (e.g., eyes or torso). The second state may be a state in which the wearable electronic device 200 is within a second angle range and/or a second acceleration range. For example, the second state may include a state in which the display module 160 of the wearable electronic device 200 is positioned to face the user's body (e.g., eyes or torso). For example, the second state may be a state other than the first state described above.

According to an embodiment, the first state (e.g., out of view) may be a state in which the user does not view or cannot view the display 161 (e.g., a screen) through his/her eyes. For example, referring to FIG. 5A, the first state may include a case in which the user of the wearable electronic device 200 crosses his/her arms with a right wrist 510 and a left wrist 520 and thus the display 161 (e.g., a screen) faces a direction (e.g., outward) opposite to the direction toward the body (e.g., eyes or torso). For example, referring to FIG. 5B, the first state may include a case in which the user wears the wearable electronic device 200 on the left wrist 520 and the display 161 (e.g., a screen) does not face the body (e.g., eyes or torso) but faces an external view. For example, referring to FIG. 5C, the first state may include a case in which the display 161 (e.g., a screen) faces a direction (e.g., outward) opposite to the direction toward the body (e.g., a leg) in a state in which the user lowers the right wrist 510 wearing the wearable electronic device 200. In various embodiments, the first state may include a state in which the user places the right wrist 510 or the left wrist 520 wearing the wearable electronic device 200 in a pocket and is thus unable to view the display 161 (e.g., a screen).

According to an embodiment, the second state (e.g., in of view) may be a state in which the user views or can view the display 161 (e.g., a screen) through his/her eyes. For example, the second state may include a case in which the user looks at a clock displayed on the display 161 (e.g., a screen) through his/her eyes or a case in which the user runs an application displayed on the display 161 (e.g., a screen) through his/her eyes. When the wearable electronic device 200 is in the second state, the processor 120 may not control touch sensitivity, a touch region (e.g., a touch area), or a touch pressure of the display module 160, but maintain the same.

FIG. 6 is a drawing schematically illustrating a configuration capable of identifying whether a wearable electronic device is in a first state or a second state by using a second sensor according to an embodiment of the disclosure.

Referring to FIG. 6, a user may wear the wearable electronic device 200 on a left wrist 520. The processor 120 of the wearable electronic device 200 may detect a gradient of a vector directed in a vertical axis direction (e.g., the z-axis direction) by using a second sensor (e.g., the second sensor 420 of FIG. 4). For example, the processor 120 may detect a tilt of the wearable electronic device 200 with reference to the vertical axis direction (e.g., the z-axis direction) of the display 161 (e.g., a screen) by using an angular velocity and/or an acceleration measured through the second sensor 420 (e.g., an inertial sensor). For example, the processor 120 may use the second sensor 420 to measure an angular velocity and an acceleration of the display 161 (e.g., a screen) rotating in direction \textcircled{1} (e.g., −direction) and/or an angular velocity and an acceleration of the display 161 (e.g., a screen) rotating in direction \textcircled{2} (e.g., +direction), with reference to the vertical axis direction (e.g., the z-axis direction) of the wearable electronic device 200.

According to an embodiment, a case in which the display 161 (e.g., a screen) of the wearable electronic device 200 rotates in the direction \textcircled{1} (e.g., −direction) may correspond to a first state in which the user does not view or cannot view the display 161 (e.g., a screen) through his/her eyes. According to various embodiments, a case in which the display 161 (e.g., a screen) rotates in the direction \textcircled{2} (e.g., +direction) may correspond to a second state in which the user views or can view the display 161 (e.g., a screen) through his/her eyes.

According to an embodiment, when the user wears the wearable electronic device 200 on the left wrist 520, if a value of a field of view (FOV) is about 0.5 or greater (e.g., cos, about 60 degrees or more) and the magnitude of an acceleration measured in the direction \textcircled{1} (e.g., −direction and y-axis direction) is about 0.4 g or greater, the processor 120 may determine that the wearable electronic device 200 is in the first state in which the user does not view or cannot view the display 161 (e.g., a screen) through his/her eyes.

According to an embodiment, the processor 120 may determine an angle at which the display 161 (e.g., a screen) of the wearable electronic device 200 is positioned with reference to the ground and the vertical axis direction (e.g., the z-axis direction), and may detect the first state in which the user cannot view the display 161 (e.g., a screen) through his/her eyes or the second state in which the user can view the display 161 (e.g., a screen) through his/her eyes.

According to an embodiment, the magnitude of the second sensor 420 may be defined through the following equation 1.

$$magnitude = \sqrt{{accx}^{2} + {accy}^{2} + {accz}^{2}} \qquad [ Equation 1 ]$$

For example, in the above equation 1, magnitude refers to the magnitude of the second sensor 420, and accx, accy, and accz may refer to acceleration sensor data of the second sensor 420 with respect to the x-axis, y-axis, and z-axis.

According to an embodiment, a field of view (FOV) of the second sensor 420 may be defined through the following equation 2.

$$FOV = arc sin ( accz , magnitude ) \qquad [ Equation 2 ]$$

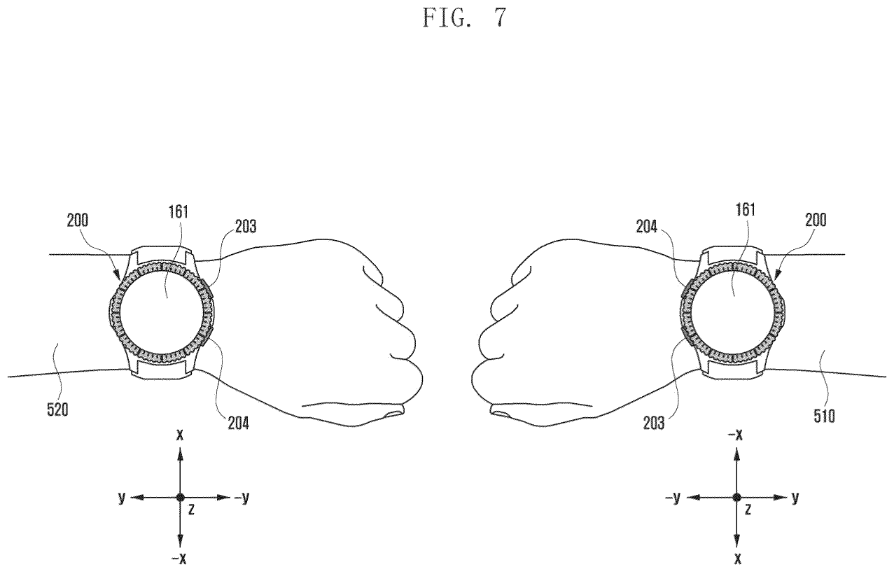

FIG. 7 is a drawing schematically illustrating an embodiment for describing axis calibration for a second sensor of a wearable electronic device according to an embodiment of the disclosure.

According to an embodiment, the processor 120 may calibrate a reference axis of the second sensor 420 in order to determine whether the wearable electronic device 200 is in a first state (e.g., out of view) or a second state (e.g., in of view) by using the second sensor 420 (e.g., an inertial sensor), regardless of whether a user has worn the wearable electronic device 200 on a right wrist 510 or a left wrist 520.

According to an embodiment, when the user wears the wearable electronic device 200 on the left wrist 520 and when the user wears the wearable electronic device 200 on the right wrist 510, the processor 120 may determine whether the wearable electronic device 200 is in the first state (e.g., out of view) or the second state (e.g., in of view) by inverting the x-axis and −x-axis and the y-axis and −y-axis of the second sensor 420 with reference to the key buttons 203 and 204.

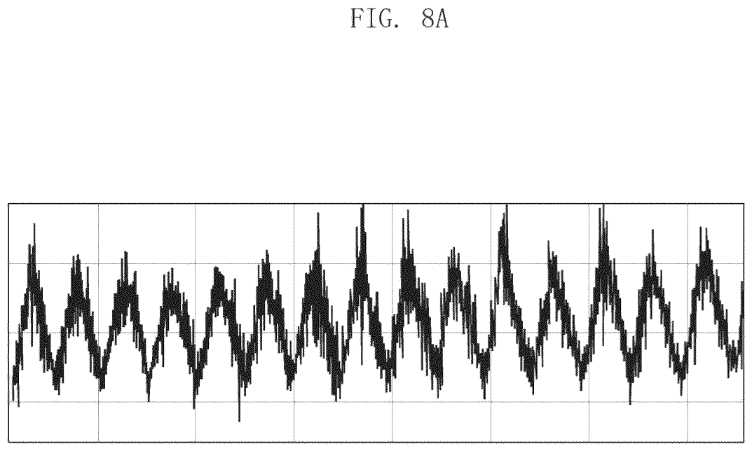

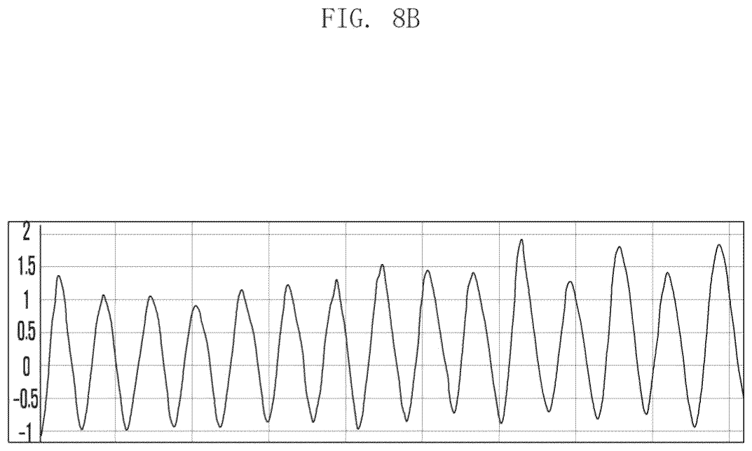

FIG. 8A is a drawing schematically illustrating a raw acceleration signal measured using a second sensor of a wearable electronic device according to an embodiment of the disclosure. FIG. 8B is a drawing schematically illustrating a signal obtained by filtering the raw acceleration signal of FIG. 8A measured using a second sensor of a wearable electronic device according to an embodiment of the disclosure.

Referring to FIG. 8A, a raw acceleration signal measured using the second sensor 420 (e.g., an inertial sensor) may include a noise signal.

According to an embodiment, the processor 120 may filter out a noise signal from a raw acceleration signal measured using the second sensor 420 in order to determine a first state (e.g., out of view) or a second state (e.g., in view of) of the wearable electronic device 200. For example, a raw acceleration signal of the second sensor 420 including a noise signal may be filtered as disclosed in FIG. 8B.

According to an embodiment, the processor 120 may filter out a noise signal from a raw acceleration signal measured using the inertial sensor 420 by using an infinite impulse response (IIR) (e.g., a single pole IIR) filter.

According to an embodiment, an output signal (y[n]) of the second sensor 420 filtered by the processor 120 may be defined through the following equation 3.

$$Y [ n ] = α x [ n ] + ( 1 - α ) y [ n - 1 ] , 0 < α < 1 \qquad [ Equation 3 ]$$

For example, in the above equation 3, Y[n] refers to a filtered output signal of the second sensor 420, x[n] refers to a raw acceleration signal measured using the second sensor 420, and a refers to a filtering coefficient of a signal, which may be a value between 0 and 1.

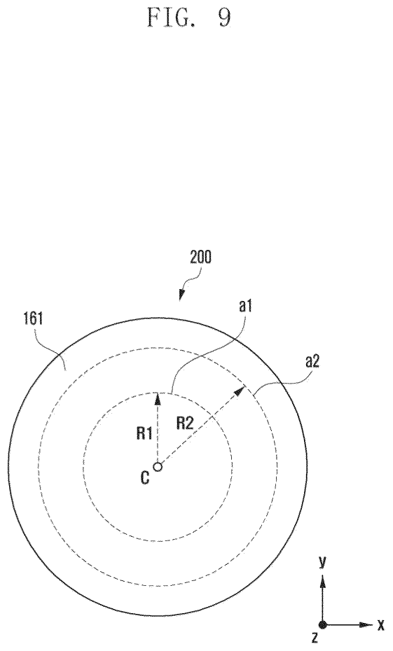

FIG. 9 is a drawing schematically illustrating an embodiment for reducing a touch region of a display module of a wearable electronic device according to an embodiment of the disclosure.

According to an embodiment, when the wearable electronic device 200 is in a first state (e.g., out of view) in which a user of the wearable electronic device 200 does not view or cannot view the display 161 (e.g., a screen), the processor 120 may control a touch region or a touch area of the display module 160 (e.g., the touch circuit 168) to be reduced.

According to an embodiment, when the wearable electronic device 200 is in the first state, the processor 120 may reduce a radius at which a touch is input from R2 to R1, or reduce a touch region (e.g., a touch area) from a2 to a1, with reference to a center point (c) (e.g., the center in the z-axis direction) of the display module 161. For example, when a touch input region (a2) of the display module 161 is about 70% to about 80% with reference to the center point (c) (e.g., the center in the z-axis direction) of the display module 161, if the wearable electronic device 200 is in the first state, the processor 120 may control the touch input region of the display module 161 to be reduced to an area (a1) reduced by about 30% to about 50%, so as to reduce the user's incorrect touch region on the display module 161.

According to an embodiment, a distance (R) (e.g., R1, R2) from the center point (c) (e.g., the center in the z-axis direction) of the display module 161 to touch coordinates may be defined through the following equation 4.

$$R = {( x - cx )}^{2} + {( y - cy )}^{2} \qquad [ Equation 4 ]$$

For example, in the above equation 4, R may be a distance from the center point (c) of the display module 161 to touch coordinates (x, y), where x and y may be touch input coordinates relative to the display module 161, and cx and cy may be coordinates of the center point (c) of the display module 161.

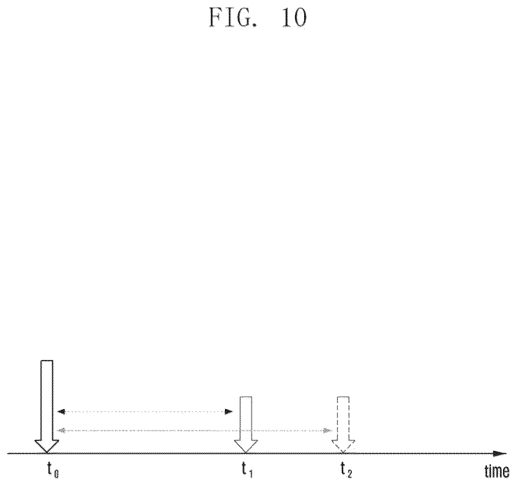

FIG. 10 is a drawing schematically illustrating an embodiment of adjusting a long press input time for a display module of a wearable electronic device according to an embodiment of the disclosure.

According to an embodiment, when the wearable electronic device 200 is in a first state (e.g., out of view) in which a user of the wearable electronic device 200 does not view or cannot view the display 161 (e.g., a screen), the processor 120 may shorten a long press input time for the display module 160 (e.g., the touch circuit 168).

According to an embodiment, when the wearable electronic device 200 is in the first state, the processor 120 may shorten a time for entering an initial screen of the wearable electronic device 200. For example, when the wearable electronic device 200 is in the first state, the processor 120 may shorten the long press input time for the display module 160 (e.g., the touch circuit 168) from t₀ to t₂ (e.g., about 3 seconds) to t₀ to t₁ (e.g., about 2 seconds), thereby reducing the time for the wearable electronic device 200 to enter the initial screen. For example, when the user of the wearable electronic device 200 crosses his/her arms and a long press input to the display module 160 (e.g., the touch circuit 168) lasts for about 2 seconds or longer, the processor 120 may cancel the entry of the wearable electronic device 200 into the initial screen.

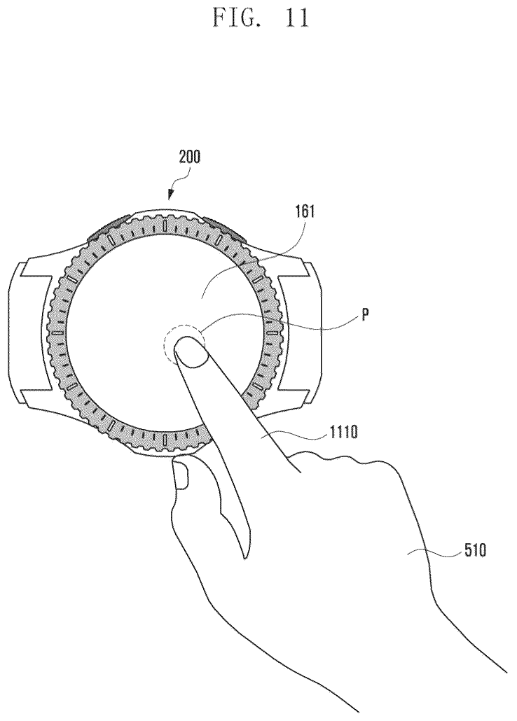

FIG. 11 is a drawing schematically illustrating an embodiment of entering an initial screen by using the shape or size of a touch input to a display module of a wearable electronic device according to an embodiment of the disclosure.

According to an embodiment, the processor 120 may detect the shape or size (e.g., area) of a touch input to the display module 160 (e.g., the touch circuit 168). For example, the processor 120 may identify whether a user of the wearable electronic device 200 touches the display module 160 (e.g., the touch circuit 168) by using his/her finger or whether a touch input occurs on the display module 160 (e.g., the touch circuit 168) by using the user's wrist while the user has his/her arms crossed.

According to an embodiment, when the user of the wearable electronic device 200 touches the display module 160 (e.g., the touch circuit 168) by using a right index finger 1110, a touch shape may be smaller and the size or area of a touch input may be smaller than when the user touches the display module 160 (e.g., the touch circuit 168) by using the wrist while the user has his/her arms crossed. For example, when the user of the wearable electronic device 200 touches the display module 160 (e.g., the touch circuit 168) by using the right index finger 1110, a touch point (P) on the display module 160 (e.g., the touch circuit 168) may have, for example, a circular shape having a small touch shape and a small size or area of a touch input. For example, when the user of the wearable electronic device 200 touches the display module 160 (e.g., the touch circuit 168) by using the wrist while the user has his/her arms crossed, the touch point (P) on the display module 160 (e.g., the touch circuit 168) may have, for example, a shape such as an oval having a larger touch shape than a circular shape and a larger size or area of a touch input. The processor 120 may identify the touch point (P) on the display module 160 (e.g., the touch circuit 168) of the wearable electronic device 200, and when the user of the wearable electronic device 200 touches the display module 160 (e.g., the touch circuit 168) by using his/her finger, control the display module 160 so as to allow entry to an initial screen of the wearable electronic device 200, based on at least one of the shape or size (e.g., area) of the touch point (P).

According to various embodiments, the processor 120 may detect a touch pressure on the display module 160 (e.g., the touch circuit 168) by using the fourth sensor 440 (e.g., a pressure sensor). For example, the processor 120 may identify a pressure related to whether the user of the wearable electronic device 200 applies a touch input to the display module 160 (e.g., the touch circuit 168) by using his/her finger or whether the user applies a touch input to the display module 160 (e.g., the touch circuit 168) by using the wrist while the user has his/her arms crossed.

According to an embodiment, when the user of the wearable electronic device 200 applies a touch pressure to the display module 160 (e.g., the touch circuit 168) by using the right index finger 1110, a touch pressure may be smaller than when the user applies a touch pressure to the display module 160 (e.g., the touch circuit 168) by using the wrist while the user has his/her arms crossed. The processor 120 may identify a touch pressure on the display module 160 (e.g., the touch circuit 168) of the wearable electronic device 200, and when the user of the wearable electronic device 200 applies a touch pressure to the display module 160 (e.g., the touch circuit 168) by using his/her finger, control the display module 160 to determine whether to enter the initial screen of the wearable electronic device 200, based on at least one of the intensity, magnitude, and strength of the pressure.

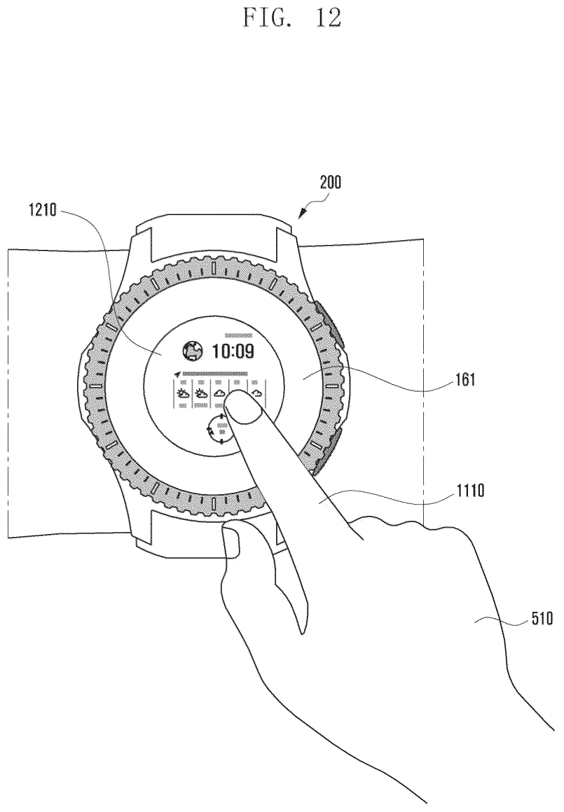

FIG. 12 is a drawing schematically illustrating an embodiment of changing an initial screen for a display module of a wearable electronic device according to an embodiment of the disclosure.

According to an embodiment, the processor 120 may control an entry to and a change of an initial screen of the wearable electronic device 200 when the processor 120 identifies a finger touch on the display module 160 (e.g., the touch circuit 168). For example, the processor 120 may identify a finger touch on the display module 160 (e.g., the touch circuit 168) through the shape or size (e.g., area) of a touch point (P). For example, the processor 120 may restrict an entry to and a change of the initial screen of the wearable electronic device 200 when a touch input occurs on the display module 160 (e.g., the touch circuit 168) by using a wrist of a user of the wearable electronic device 200 while the user has his/her arms crossed. For example, the processor 120 may identify a wrist touch on the display module 160 (e.g., the touch circuit 168) through the shape or size (e.g., area) of the touch point (P).

According to an embodiment, when the user of the wearable electronic device 200 touches a user interface 1210 displayed on the display module 160 by using a right index finger 1110, the processor 120 may enter the initial screen displayed through the user interface 1210 and change the initial screen.

According to various embodiments, when the user of the wearable electronic device 200 touches the user interface 1210 displayed on the display module 160 by using the wrist while the user has his/her arms crossed, the processor 120 may not perform an entry to and a change of the initial screen displayed through the user interface 1210. For example, when a touch signal is input to the display module 160 while the wearable electronic device 200 is in a first state (e.g., out of view), the processor 120 may restrict an entry to the user interface 1210 and a change of a configuration screen.

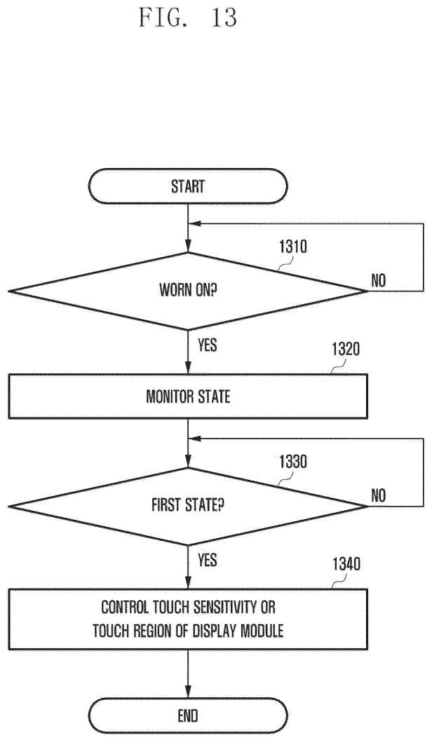

FIG. 13 is a schematic flowchart illustrating a method for controlling a wearable electronic device according to an embodiment of the disclosure.

According to an embodiment, a method disclosed in FIG. 13 may, for example, be performed through the components of the wearable electronic device 200 disclosed in FIG. 4. The method disclosed in FIG. 13 may include, for example, the embodiments disclosed in FIGS. 1A to 12.

In operation 1310, the processor 120 may identify whether a user has worn the wearable electronic device 200 on his/her wrist by using the sensor module 176 (e.g., the first sensor 410 (e.g., an infrared sensor) of FIG. 4).

In operation 1320, when the wearable electronic device 200 is worn on the user's wrist, the processor 120 may monitor a state (e.g., a first state or a second state) of the wearable electronic device 200 by using a second sensor (e.g., the second sensor 420 (e.g., an inertial sensor) of FIG. 4).

According to an embodiment, when the wearable electronic device 200 is worn on the user's wrist, the processor 120 may activate at least one of the second sensor 420 (e.g., an inertial sensor), the third sensor 430 (e.g., an illuminance sensor), and the fourth sensor 440 (e.g., a pressure sensor) and/or monitor the state (e.g., a first state or a second state) of the wearable electronic device 200.

In operation 1330, the processor 120 may identify whether the wearable electronic device 200 is in a first state (e.g., out of view) or a second state (e.g., in of view) by using the second sensor 420.

According to an embodiment, the first state may be a state in which the user does not view or cannot view the display 161 (e.g., a screen) through his/her eyes. The second state may be a state in which the user views or can view the display 161 (e.g., a screen) through his/her eyes.

In operation 1340, when the wearable electronic device 200 is in the first state, the processor 120 may control touch sensitivity or a touch region (e.g., a touch area) of the display module 160.

According to an embodiment, when the wearable electronic device 200 is in the first state, the processor 120 may reduce the touch sensitivity or the touch region (e.g., a touch area) of the display module 160.

According to various embodiments, when the wearable electronic device 200 is not worn on the user's wrist or when the wearable electronic device 200 is in the second state, the processor 120 may not control the touch sensitivity or the touch region (e.g., a touch area) of the display module 160, but maintain the same.

A wearable electronic device 200 according to an embodiment of the disclosure may include a display module 160 including a display 161 and a touch circuit 168, a sensor module 176 including a first sensor 410 and a second sensor 420, a memory 130, and a processor 120 operatively connected to the display module 160, the sensor module 176, and the memory 130. According to an embodiment, the processor 120 may identify whether the wearable electronic device 200 is worn on a wrist of a user by using the first sensor 410. According to an embodiment, the processor 120 may monitor a state of the wearable electronic device 200 by using the second sensor 420 when the wearable electronic device 200 is worn on the wrist of the user. According to an embodiment, the processor 120 may identify whether the wearable electronic device 200 is in a first state or a second state by using the second sensor 420. According to an embodiment, the processor 120 may control touch sensitivity or a touch region of the display module 160 when the wearable electronic device 200 is in the first state.

According to an embodiment, the processor 120 may be configured to identify, as the first state, a state in which the display 161 is positioned to face a direction away from a body of the user of the wearable electronic device 200, by using the second sensor 420.

According to an embodiment, the processor 120 may be configured to identify, as the second state, a state in which the display 161 is positioned to face the body of the user of the wearable electronic device 200, by using the second sensor 420.

According to an embodiment, the processor 120 may be configured to, by using the sensor module 176, identify a case in which the user of the wearable electronic device 200 crosses his/her arms and thus the display 161 faces a direction away from the user's body, a case in which the display 161 faces a direction away from the user's body in a state in which the user lowers the wrist wearing the wearable electronic device 200, or a state in which the user places the wrist wearing the wearable electronic device 200 in a predetermined location and is thus unable to view the display 161, as the first state.

According to an embodiment, the processor 120 may be configured to, by using the second sensor 420, identify, as the first state, a state in which the user of the wearable electronic device 200 does not view or is unable to view the display 161 through his/her eyes, and identify, as the second state, a state in which the user of the wearable electronic device 200 views or is able to view the display 161 through his/her eyes.

According to an embodiment, the processor 120 may be configured to, when the wearable electronic device 200 is in the first state, reduce the touch sensitivity or the touch region of the display module 160.

According to an embodiment, the sensor module 176 may further include a fourth sensor 440, and the processor 120 may be configured to, by using the fourth sensor 440, determine whether to enter an initial screen displayed on the display module 160, based on an intensity or a magnitude of a pressure applied to the display module 160.

According to an embodiment, the processor 120 may be configured to, when the wearable electronic device 200 is in the first state, shorten a time for entering an initial screen of the wearable electronic device 200 displayed through the display module 160.

According to an embodiment, the processor 120 may be configured to determine whether to enter an initial screen displayed on the display module 160, based on a shape or an area of a touch point (P) on the display module 160.

According to an embodiment, the processor 120 may be configured to change an initial screen displayed on the display module 160 or restrict a change of the initial screen, based on a shape or an area of a touch point (P) on the display module 160.

A method for controlling a wearable electronic device 200 according to an embodiment of the disclosure may include an operation of identifying, by a processor 120, whether the wearable electronic device 200 is worn on a wrist of a user, by using a first sensor 410. According to an embodiment, the method may include an operation of monitoring, by the processor 120, a state of the wearable electronic device 200 by using a second sensor 420 when the wearable electronic device 200 is worn on the wrist of the user. According to an embodiment, the method may include an operation of identifying, by the processor 120, a first state or a second state of the wearable electronic device 200 by using the second sensor 420. According to an embodiment, the method may include an operation of controlling, by the processor 120, touch sensitivity or a touch region of a display module 160 when the wearable electronic device 200 is in the first state.

According to an embodiment, the method may include an operation of identifying, by the processor 120, a state in which a display 161 of the display module 160 is positioned to face a direction away from a body of the user of the wearable electronic device 200, as the first state, by using the second sensor 420.

According to an embodiment, the method may include an operation of identifying, by the processor 120, a state in which the display 161 is positioned to face the body of the user of the wearable electronic device 200, as the second state, by using the second sensor 420.

According to an embodiment, the method may include an operation of identifying, by the processor 120, a case in which the user of the wearable electronic device 200 crosses his/her arms and thus the display 161 of the display module 160 faces a direction away from the user's body, a case in which the display 161 faces a direction away from the user's body in a state in which the user lowers the wrist wearing the wearable electronic device 200, or a state in which the user places the wrist wearing the wearable electronic device 200 in a pocket and is thus unable to view the display 161, as the first state, by using the second sensor 420.

According to an embodiment, the method may include an operation of identifying, by the processor 120, a state in which the user of the wearable electronic device 200 does not view or is unable to view the display 161 of the display module 160 through his/her eyes, as the first state, by using the second sensor 420.

According to an embodiment, the method may include an operation of identifying, by the processor 120, a state in which the user of the wearable electronic device 200 views or is able to view the display 161 through his/her eyes, as the second state, by using the second sensor 420.

According to an embodiment, the method may include an operation of reducing, by the processor 120, the touch sensitivity or the touch region of the display module 160 when the wearable electronic device 200 is in the first state.

According to an embodiment, the method may include an operation of determining, by the processor 120, whether to enter an initial screen displayed on the display module 160, by using a fourth sensor 440, based on an intensity or a magnitude of a pressure applied to the display module 160.

According to an embodiment, the method may include an operation of shortening, by the processor 120, a time for entering an initial screen of the wearable electronic device 200 displayed through the display module 160 when the wearable electronic device 200 is in the first stat.

According to an embodiment, the method may include an operation of determining, by the processor 120, whether to enter an initial screen displayed on the display module 160, based on a shape or an area of a touch point (P) on the display module 160.

According to an embodiment, the method may include an operation of, by the processor 120, changing an initial screen displayed on the display module 160 or restricting a change of the initial screen, based on a shape or an area of a touch point (P) on the display module 160.

According to an embodiment, the method for controlling the wearable electronic device may be performed by using a non-transitory computer-readable storage medium storing one or more programs. The one or more programs according to an embodiment may include instructions (e.g., commands) for performing at least one operation related to the method for controlling the wearable electronic device.

In the above, although the disclosure has been described with reference to various embodiments of the disclosure, it is obvious to those skilled in the art that modifications and changes can be made thereto without departing from the technical spirit and scope of the disclosure.

What is claimed is:

1. A wearable electronic device comprising:
a display interface comprising a display and a touch circuit;
a sensor interface comprising a first sensor and a second sensor;
a memory configured to store instructions; and
at least one processor operatively connected to the display interface, the sensor interface, and the memory,
wherein the instructions, when executed by the at least one processor, cause the wearable electronic device to:
identify whether the wearable electronic device is worn on a wrist of a user, by using the first sensor;
based on identifying the wearable electronic device is worn on the wrist of the user, monitor a state of the wearable electronic device by using the second sensor;
identify whether the wearable electronic device is in a first state or a second state; and
based on the wearable electronic device being in the first state, control a touch sensitivity or a touch region of the display interface.

2. The wearable electronic device of claim 1, wherein the instructions, when executed by the at least one processor, cause the wearable electronic device to identify, as the first state, a case in which the display is positioned to face a direction away from a body of the user of the wearable electronic device, by using the second sensor.

3. The wearable electronic device of claim 1, wherein the instructions, when executed by the at least one processor, cause the wearable electronic device to identify, as the second state, a case in which the display is positioned to face a body of the user of the wearable electronic device, by using the second sensor.

4. The wearable electronic device of claim 1, wherein the instructions, when executed by the at least one processor, cause the wearable electronic device to, using the sensor interface, identify, as the first state:
a case in which the user of the wearable electronic device crosses arms and thus the display faces a direction away from the a body of the user, a case in which the display faces a direction away from the body of the user in a state in which the user lowers the wrist wearing the wearable electronic device, or a case in which the user places the wrist wearing the wearable electronic device) in a predetermined location.

5. The wearable electronic device of claim 1, wherein the instructions, when executed by the at least one processor, cause the wearable electronic device to, using the second sensor, identify, as the first state, a case in which the user of the wearable electronic device does not view or is unable to view the display through eyes, and identify, as the second state, a case in which the user of the wearable electronic device views or is able to view the display through the eyes.

6. The wearable electronic device of claim 1, wherein the instructions, when executed by the at least one processor, cause the wearable electronic device to, based on the wearable electronic device being in the first state, reduce the touch sensitivity or the touch region of the display interface.

7. The wearable electronic device of claim 1, wherein the sensor interface further comprises a fourth sensor, and
wherein the instructions, when executed by the at least one processor, cause the wearable electronic device to, using the fourth sensor, determine whether to enter an initial screen displayed on the display interface, based on an intensity or a magnitude of a pressure applied to the display interface.

8. The wearable electronic device of claim 1, wherein the instructions, when executed by the at least one processor, cause the wearable electronic device to, based on the wearable electronic device being in the first state, shorten a time for entering an initial screen of the wearable electronic device displayed through the display interface.

9. The wearable electronic device of claim 1, wherein the instructions, when executed by the at least one processor, cause the wearable electronic device to determine whether to enter an initial screen displayed on the display interface, based on a shape or an area of a touch point on the display interface.

10. The wearable electronic device of claim 1, wherein the instructions, when executed by the at least one processor, cause the wearable electronic device to change an initial screen displayed on the display interface or restrict a change of the initial screen, based on a shape or an area of a touch point on the display interface.

11. A method for controlling a wearable electronic device, the method comprising:
identifying, by at least one processor, whether the wearable electronic device is worn on a wrist of a user, by using a first sensor;
based on identifying the wearable electronic device is worn on the wrist of the user, monitoring, by the at least one processor, a state of the wearable electronic device by using a second sensor;
identifying, by the at least one processor, whether the wearable electronic device is in a first state or a second state by using the second sensor; and
based on the wearable electronic device being in the first state, controlling, by the at least one processor, a touch sensitivity or a touch region of a display interface.

12. The method of claim 11, further comprising identifying, by the at least one processor, a case in which a display of the display interface is positioned to face a direction away from a body of the user of the wearable electronic device, as the first state, by using the second sensor.

13. The method of claim 12, further comprising identifying, by the at least one processor, a case in which the display is positioned to face the body of the user of the wearable electronic device, as the second state, by using the second sensor.

14. The method of claim 11, further comprising identifying, by the at least one processor, using the second sensor, as the first state:
a case in which the user of the wearable electronic device crosses arms and thus a display of the display interface faces a direction away from a body of the user, a case in which the display faces a direction away from the body of the user in a state in which the user lowers the wrist wearing the wearable electronic device, or a case in which the user places the wrist wearing the wearable electronic device in a predetermined location.

15. The method of claim 11, further comprising:
identifying, by the at least one processor, a state in which the user of the wearable electronic device does not view or is unable to view a display of the display interface through eyes, as the first state, by using the second sensor; and
identifying, as the second state, a state in which the user of the wearable electronic device views or is able to view the display through the eyes.

16. The method of claim 11, further comprising, based on the wearable electronic device being in the first state, reducing, by the at least one processor, the touch sensitivity or the touch region of the display interface.

17. The method of claim 11, further comprising, determining, by the at least one processor, whether to enter an initial screen displayed on the display interface, based on an intensity or a magnitude of a pressure applied to the display interface using a fourth sensor.

18. The method of claim 11, further comprising, based on the wearable electronic device being in the first state, shortening, by the at least one processor, a time for entering an initial screen of the wearable electronic device displayed through the display interface.

19. The method of claim 11, further comprising, determining, by the at least one processor, whether to enter an initial screen displayed on the display interface, based on a shape or an area of a touch point on the display interface.

20. A non-transitory computer-readable storage medium configured to store one or more computer programs including instructions that, when executed by at least one processor, cause a wearable electronic device to:
identifying whether the wearable electronic device is worn on a wrist of a user, by using a first sensor;
based on identifying the wearable electronic device is worn on the wrist of the user, monitoring a state of the wearable electronic device by using a second sensor;
identifying whether the wearable electronic device is in a first state or a second state by using the second sensor; and
based on the wearable electronic device being in the first state, controlling a touch sensitivity or a touch region of a display interface.
